(19) United States
(12) Patent Application Publication
(10) Pub. No.: US 2022/0087122 A1
(43) Pub. Date: Mar. 24, 2022

(54) BICOLORED PLANT CULTIVATION APPARATUS

(71) Applicant: FUJIAN SANAN SINO-SCIENCE PHOTOBIOTECH CO., LTD., Quanzhou (CN)

(72) Inventors: Shaohua LI, Xiamen (CN); Jing LI, Xiamen (CN); Huaqin GONG, Xiamen (CN); Zhiyin LI, Xiamen (CN); Ying CHEN, Xiamen (CN); Peng LI, Xiamen (CN)

(21) Appl. No.: 17/543,822

(22) Filed: Dec. 7, 2021

Related U.S. Application Data
(62) Division of application No. 16/690,128, filed on Nov. 21, 2019.

(51) Int. Cl. A01G 31/02

(52) U.S. Cl. CPC A01G 31/02

(57) ABSTRACT

The disclosure discloses a bicolored plant cultivation apparatus. It contains two parts: a cultivation tank and a planting plate which can be assembled as a cavity for storing nutrient solutions and nutrient aerosols, or both can be used separately. In order to create a dark environment inside the cavity, the surface of inner bottom and lateral walls of the cultivation tank, the lower surface of the planting plate, or at least one of them will be coated with one layer of light blocking material. The principle behind the disclosure is to minimize the light intensity below the planting plate in order to provide a low light environment which is suitable for plant root growth and inhibits the alga growth at the same time. The preparation methods of the light-blocking layer include coating, injection moulding, lamination, adhesion and spraying.

### CROSS REFERENCE TO RELATED APPLICATION

This is a divisional application of US national phase application Ser. No. 16/690,128 filed on Nov. 21, 2019 which is a continuation application claiming priority to a pending PCT application PCT/CN2018/085443, filed on May 3, 2018, which claims the priority to a Chinese application No. 2017103659300, filed on May 22, 2017, both of which are hereby incorporated by reference in their entireties, including any appendices or attachments thereof, for all purpose.

### BACKGROUND OF THE PRESENT DISCLOSURE

### Field of Disclosure

The present disclosure belongs to the field of plant cultivation techniques, and specifically to a bicolored plant cultivation apparatus.

### Description of Related Arts

Over the past years, the controlled environment facilities and plant factories are booming all over the world. In order to improve crop yield and quality, hydroponic and aeroponic technology are widely adopted due to their salient features that are favourable for balanced, comprehensive and rapid uptake of nutrients by crops. One big challenge that both techniques are facing is alga growth as algae are prone to large-scale reproduction in a moist environment and cannot be eliminated easily. Fast growing algae will compete for nutrients from cultivated crops under nutrient solution or aerosol culture mode. The running cost of a plant factory will also increase dramatically by manually cleaning algae-contaminated cultivation apparatus. Currently, artificial lighting accounts for the largest share of energy consumption in a plant factory. Improving the efficiency of light utilization for crops has become one of the important objectives to be achieved in a plant factory in order to lower the production cost. A cultivation apparatus which can improve light use efficiency for crops and inhibit alga growth in the nutrient solutions is of great significance for the industry.

Currently, most of the traditional cultivation apparatuses for hydroponics and aeroponics use foam rafts or plastic films. The foam raft material is not environmental friendly and difficult to decontaminate when algae are growing. A light-proof aeroponic cultivation tank outlined in CN201726700U uses a plastic film to block light from entering its nutrient solution tank in order to prevent alga growth. But the plastic film is not durable and can only be used for a short time period. Routine replacement work is needed which is time-consuming and laborious. In CN204560490U, the splicing gap between two planting plates is reduced to prevent light leakage which will result in high manufacturing cost. All the apparatus mentioned above are inconvenient to move and not suitable for mechanized operation. Meanwhile, there is no cultivation apparatus that can prevent light from entering its cultivation tank with low manufacturing and maintenance cost. Another attempt by using an aluminized mirror that has good reflective properties is outlined in CN106465652A. However, the preparation process of aluminized mirror is complex and expensive. The mirror itself is easily oxidized and not durable during the cleaning process. In CN103039343A, the planar structure of a cultivation tank has been changed into L-shape which is not applicable to some scenarios where a flat surface is needed.

### SUMMARY OF THE PRESENT DISCLOSURE

The present disclosure provides a bicolored plant cultivation apparatus that will overcome the defects of the traditional technology for a plant factory.

The present disclosure provides a bicolored plant cultivation apparatus, including a cultivation tank and a planting plate to support crop growth. The planting plate couples with the tank to form a closed cavity for storing nutrient solutions. The lower surface of the planting plate is coated with one light-blocking layer to ensure that no light can penetrate the planting plate. In another word, the cavity will create a low light environment for plant root and prevent the growth of algae inside the nutrient solutions. The preparation methods of the light-blocking layer include injection moulding, film coating, adhesion, squeezing, thermal transfer printing or thermoforming.

In a preferred implementation solution of the present disclosure, the upper surface of the planting plate, the outer wall and bottom surface of the cultivation tank will be coated with one light reflective layer including white, light grey or fluorescence colour to enhance light reflection which will help to improve light use efficiency for crops. The preparation methods for the light reflective layer include injection moulding, film coating, adhesion, squeezing, thermal transfer printing or thermoforming.

In a preferred implementation solution of the present disclosure, the inner lateral wall and bottom surfaces of the cultivation tank will be coated with one light-blocking layer, including black, blue, purple, dark grey or green colour which will help to further reduce the light intensity inside the cavity.

In a preferred implementation solution of the present disclosure, the colour of the light-blocking layer can be black, blue, purple, dark grey, or green.

In a preferred implementation solution of the present disclosure, several planting through-holes can be found on the planting plate.

In a preferred implementation solution of the present disclosure, a thickness of the light-blocking layer is in a range of 2.5-3.5 mm.

In a preferred implementation solution of the present disclosure, a thickness of the light reflective layer is in a range of 2.5-3.5 mm.

In a preferred implementation solution of the present disclosure, a coloured plastic with light-blocking effect can be used as the light-blocking layer; the plastic layer can be fixed onto one side of the planting plate through injection moulding, lamination, adhesion, squeezing or thermoforming; or, the layer can be made by using coloured film with light blocking effect. The film can be fixed onto one side of the planting plate through coating, lamination, adhesion or thermal transfer printing.

In a preferred implementation solution of the present disclosure, a coloured plastic with light reflective effect can be used to make the light reflective layer; the plastic layer can be fixed onto one side of the planting plate through injection moulding, lamination, adhesion, squeezing or thermoforming; or the layer can be made by using coloured film with light reflective effect. The film can be fixed onto one side of the planting plate through coating, lamination, adhesion or thermal transfer printing.

In a preferred implementation solution of the present disclosure, coloured plastics with light blocking effect can be used to make the planting plate and the cultivation tank.

The present disclosure further provides a bicolored plant cultivation apparatus, including a cultivation tank and a planting plate, the planting plate couples with the cultivation tank to form a closed cavity to store a nutrient solution or a nutrient aerosol. At least one of an inner lateral wall surface of the cultivation tank, an inner bottom surface of the cultivation tank, and a lower surface of the planting plate is coated with a light-blocking layer. The cavity creates a low light environment for plant root and reduces growth of algae inside the nutrient solution or the nutrient aerosol. A preparation method of the light-blocking layer includes injection moulding, film coating, adhesion, squeezing, thermal transfer printing or thermoforming.

The present disclosure further provides a method for manufacturing a bicolored plant cultivation apparatus, including: assembling a planting plate above a cultivation tank to form a closed cavity for storing a nutrient solution or a nutrient aerosol; and coating a light-blocking layer on a lower surface of the planting plate. The cavity creates a low light environment for plant root and reduces growth of algae inside the nutrient solution or the nutrient aerosol. The light-blocking layer is fabricated by injection moulding, film coating, adhesion, squeezing, thermal transfer printing or thermoforming.

The present disclosure has the following advantages:

1. A low light environment which is beneficial for crop root development will be created inside the cavity formed by assembling the cultivation tank and the planting plate together with light blocking coatings on the inner surface of the bicolored cultivation apparatus.

2. The alga growth inside the cavity can be prevented as not enough light is available for alga photosynthesis. Without the competition from algae, the oxygen content, pH and EC values of nutrient solutions will be more stable which are beneficial for crop development.

3. The light use efficiency by crops can be enhanced by the light reflective layer on the outer surface of the bicolored cultivation apparatus to reduce the energy loss for a plant factory.

4. The present disclosure is simple in structure and can be manufactured through different manners. For example, the planting plate can be manufactured by one-step moulding; the cultivation tank can be made either through one-step moulding or stitching several moulded parts together, and both manufacturing processes are suitable for mechanized batch production.

### BRIEF DESCRIPTION OF THE DRAWINGS

FIG. 1 is a structure cross-sectional diagram for a bicolored cultivation apparatus according to Embodiment 1 and Embodiment 2 of the present disclosure.

FIG. 2 is a schematic distribution diagram where there are total 9 light monitoring points for the bicolored cultivation apparatus according to Embodiment 3 of the present disclosure.

FIG. 3 is a photo where a large number of algae can be found in the nutrient solution of a conventional cultivation apparatus without light blocking effect after cultivation for 25 days according to Embodiment 4 of the present disclosure.

FIG. 4 is a photo where no alga can be found in the nutrient solution of the bicolored cultivation apparatus after cultivation for 25 days according to Embodiment 4 of the present disclosure

FIG. 5 is a microscopic photograph of the nutrient solution from FIG. 3 with 40 times magnification according to Embodiment 4 of the present disclosure.

FIG. 6 is a microscopic photograph of the nutrient solution from FIG. 3 with 400 times magnification according to Embodiment 4 of the present disclosure.

FIG. 7 is a microscopic photograph of the nutrient solution from FIG. 4 with 40 times magnification according to Embodiment 4 of the present disclosure.

FIG. 8 shows the leaf length comparison between plants from a conventional cultivation apparatus without light blocking effect coatings and from the bicolored cultivation apparatus according to Embodiment 4 of the present disclosure.

FIG. 9 shows the leaf width comparison between plants from a monochrome cultivation apparatus without light blocking effect coatings and from the bicolored cultivation apparatus according to Embodiment 4 of the present disclosure.

FIG. 10 shows the plant comparison between the monochrome cultivation apparatus without light blocking effect coatings and the bicolored cultivation apparatus according to Embodiment 4 of the present disclosure.

FIG. 11 shows the plant comparison between the monochrome cultivation apparatus without light blocking effect coatings and the bicolored cultivation apparatus according to Embodiment 4 of the present disclosure.

FIG. 12 shows the root comparison between the monochrome cultivation apparatus without light blocking effect coatings and the bicolored cultivation apparatus according to Embodiment 4 of the present disclosure.

FIG. 13 is a schematic cross-sectional diagram of a bicolored plant cultivation apparatus disclosed in the present disclosure.

FIG. 14 is a schematic cross-sectional diagram of the bicolored plant cultivation apparatus disclosed in an embodiment of the present disclosure.

FIG. 15 illustrates a flow chart of a method for manufacturing the bicolored plant cultivation apparatus.

### DETAILED DESCRIPTION OF THE PREFERRED EMBODIMENTS

The implementation modes of the present disclosure are described below through embodiments in which the advantages and efficacy of the disclosure are fully disclosed.

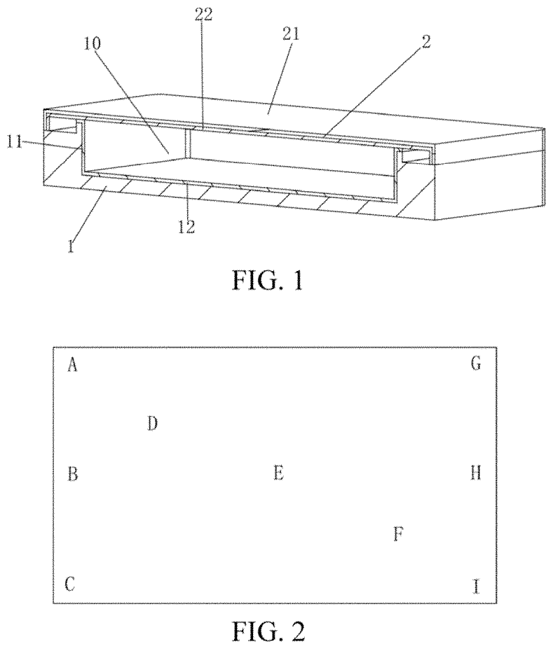

Embodiments of the bicolored cultivation apparatus are shown in FIGS. 1-14. It should be noted that the structure, scale, and size of the drawings are for illustration purpose without substantial technical meanings, so it is not for limiting the conditions for the implementation of the present disclosure. Any structural modifications, changes of scale, size adjustments without affecting the efficacy and purpose of the present disclosure should remain within the scope of the technical content disclosed by the present disclosure. Meanwhile, terms such as “upper”, “lower”, “left”, “right”, “middle” and “one” mentioned in this specification are for clarification purpose, but not intended to limit the implementation scope of the present disclosure. On the premise of no substantial change in technical contents, changes or adjustments in relative position should be within the implementation scope of the present disclosure.

The bicolored plant cultivation apparatus disclosed in the present disclosure makes full use of the materials with different light reflection and transmission properties in order to create a suitable physical environment for plant growth. Based on plant cultivation requirements in a plant factory, one material with good light reflective effect is used as an outer coating of the cultivation tank and the planting plate to achieve the maximum light reflection in order to improve the light use efficiency for crops. Another material with light blocking effect is used as an inner surface coating of the cultivation tank and lower surface coating of the planting plate, so that light intensity inside the cultivation tank is kept at a low level in which algae cannot grow. Without the competition from algae, a stable nutrient environment with enough oxygen content will benefit root development under nutrient solution or aerosol culture mode to enhance crop productivity.

### Embodiment 1

As shown in FIG. 1, a bicolored plant cultivation apparatus includes a cultivation tank 1 and a planting plate 2 with planting through-holes. The planting plate 2 fits with the cultivation tank 1 to form a closed cavity 10 for storing nutrient solutions or nutrient aerosols. In order to create a dark environment inside the cavity to prevent algae from growth, the inner lateral wall surface of the cultivation tank 1, the inner bottom surface of the cultivation tank 1 and the lower surface of the planting plate 2 are coated with one layer of light blocking materials. The low light environment inside the cavity is suitable for plant root development. The preparation methods for the light-blocking layer include coating, injection moulding, lamination, adhesion and spraying.

Preferably, the upper surface of the planting plate 2, the outer wall surface of the cultivation tank 1 plus the outer bottom surface of the cultivation tank 1 are coated with a light reflective layer 21 to enhance light reflection and help the plants achieve the highest light use efficiency (with lesser energy consumption at the same time). The light reflective layer 21 is in a white, light grey, or fluorescent colour. The preparation methods for the light reflective layer 21 include coating, injection moulding, lamination, adhesion and spraying. A preferred light reflective material must have a reflective rate greater than 75%.

Preferably, the light-blocking layers include a first light-blocking layer 11, a second light-blocking layer 12, and a third light-blocking layer 22. The first light-blocking layer 11 is disposed on the inner wall of the cultivation tank 1. The second light-blocking layer 12 is disposed on the inner bottom of the cultivation tank 1. The first light-blocking layer 11 and the second light-blocking layer 12 are connected with each other as a whole. The third light-blocking layer 22 is disposed on the lower surface of the planting plate 2.

Preferably, the above mentioned light blocking material is in a black, blue, purple, dark grey, or green colour.

Preferably, the planting plate 2 and the cultivation tank 1 are made of plastics with certain light transmittance property.

### Embodiment 2

As shown in FIG. 1, a bicolored plant cultivation apparatus includes a cultivation tank 1 and a planting plate 2.

The inner lateral wall of the cultivation tank 1 is coated with a first light-blocking layer 11, and the bottom surface of the cultivation tank 1 is coated with a second light-blocking layer 12.

To facilitate the light reflection, the upper surface of the planting plate 2 is coated by one layer of light reflective material 21 with more than 75% light reflective rate. And the reflected light can be utilized by crops in a plant factory to further reduce energy consumption. Its lower surface is coated with a third light-blocking layer 22. A plurality of planting through-holes is placed at the planting plate 2. The shape of the planting through-hole could be circular, rectangular or elliptical.

The planting plate 2 fits with the cultivation tank 1 with the first light-blocking layer 11, the second light-blocking layer 12 and the third light-blocking layer 22 to form a cavity 10 for storing nutrient solutions or nutrient aerosols. A low light environment with 0 to 5 μmol/m²·s⁻¹ light intensity will be created inside the cavity 10 to prevent alga growth and provide a suitable dark environment for root development.

Preferably, the first light-blocking layer 11, the second light-blocking layer 12, and the third light-blocking layer 22 are black in colour, while the light reflective layer 21 is in a white, light grey, or fluorescent colour. All layers can be prepared through coating, injection moulding, lamination, adhesion or spraying. For further optimization, the first light-blocking layer 11 and the second light-blocking layer 12 will be connected as a whole.

The colour range of the light reflective materials in the present disclosure is not limited to a white, light grey, or fluorescent colour. The colour range of the light blocking materials is not limited to black, blue, purple, dark grey, and green. All materials with light transmittance between 0 to 5 μmol/m²·s⁻¹ are included in the present disclosure. The preparation methods for light blocking and reflective layers includes coating, injection moulding, lamination, adhesion or spraying, while other preparation processes that can achieve the same effect also fall within the scope of the present disclosure.

Preferably, the materials used for making the planting plate 2 and the cultivation tank 1 except for light reflective layer and light-blocking layer must be with certain light transmittance property in which plastics are more preferable for this purpose.

### Embodiment 3

Experimental settings: a bicolored plant cultivation apparatus made by polypropylene (PP) without planting through-holes from Embodiment 1 of the present disclosure.

Light intensity measurement: Light intensities are measured at 9 points (A-I) located on the planting plate of the bicolored plant cultivation apparatus as shown in FIG. 2. Light intensities are either measured 2 cm above the planting plate or 2 cm below the planting plate which is inside the cavity. The measured light intensities are shown in Table 1.

TABLE 1
Light intensities (unit: μmol/m² · s⁻¹) above and below the
planting plate of the bicolored plant cultivation apparatus

| | A | B | C | D | E | F | G | H | I |
|---|---|---|---|---|---|---|---|---|---|
| Above planting | 286 | 291 | 269 | 311 | 330 | 308 | 276 | 284 | 280 |
| plate | | | | | | | | | |
| Below planting | — | — | — | — | — | — | — | — | — |
| plate | | | | | | | | | |

In summary, the light-blocking layer on the inner surface of the planting plate can achieve the effect to prevent light from entering the cavity of the bicolored plant cultivation apparatus consistent with the present disclosure, and the light reflective layer on the outer surface of the planting plate can achieve the effect to ensure that plants absorb more light. The bicolored plant cultivation apparatus can make full use of light energy, effectively prevent algae, enable plants to absorb sufficient nutrients to grow well and rapidly, improve efficiency, and reduce costs.

### Embodiment 4

Crop growth comparison experiments were conducted by using a bicolored plant cultivation apparatus and an existing non-coating cultivation apparatus.

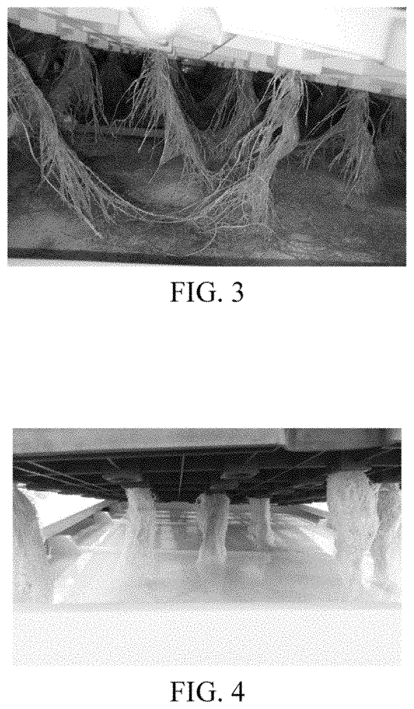

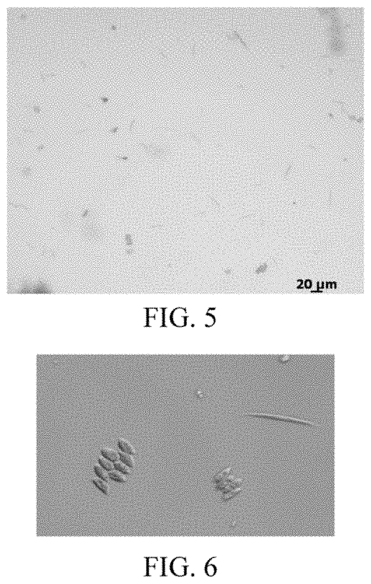

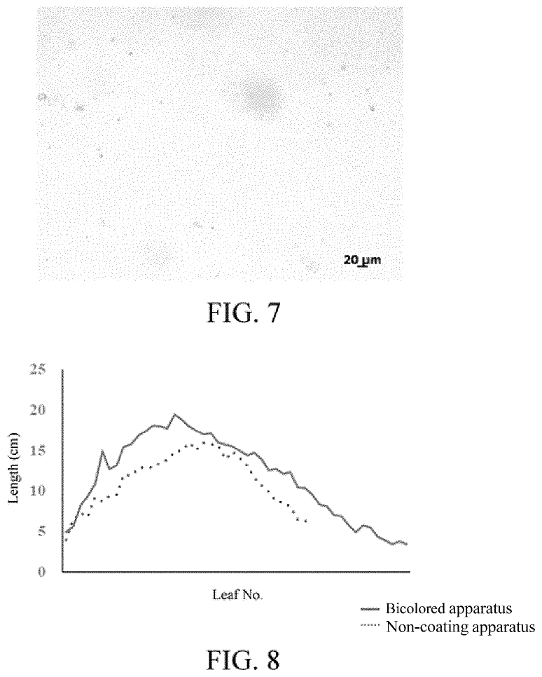

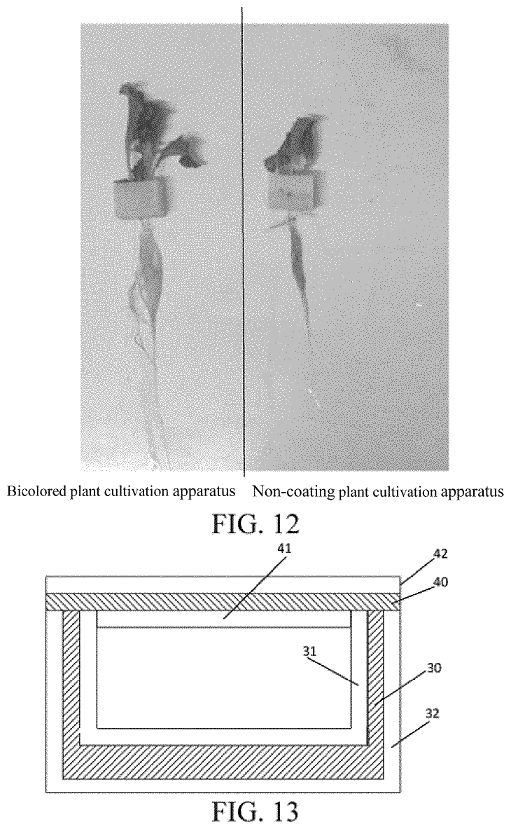

1. Algae counting in the nutrient solution: After lettuces were cultivated for 25 days, a large number of algae can be found in the conventional non-coating cultivation apparatus (as shown in FIG. 3, FIG. 5, FIG. 12 and Table 2) with different algae varieties (as shown in FIG. 6). No algae can be detected from the bicolored plant cultivation apparatus (as shown in FIG. 4, FIG. 7 and Table 2).

TABLE 2
Algae counting for both non-coating and
bicolored plant cultivation apparatus

| | Quantity of algae |
|---|---|
| Non-coating plant cultivation apparatus | 6.82 × 10⁴/mL |
| bicolored plant cultivation apparatus | 0 |

2. EC and pH values of the nutrient solution: as shown in Table 3, from Day 1 to Day 7, the EC and pH values changed 0.3 and 0.7, respectively for non-coating plant cultivation apparatus while both values only changed 0.2 for bicolored plant cultivation apparatus. Obviously, the algae competed with crops for nutrients which will significantly affect the growth environment under nutrient solution mode. Therefore, the EC and pH values would have to be adjusted back to 1.5 and 6.5 on Day 8 for non-coating plant cultivation apparatus. Light intensities of the corresponding points are undetectable inside the device.

TABLE 3
Dynamic changes in EC and pH values of the nutrient solutions
in a non-coating plant cultivation apparatus and a bicolored
plant cultivation apparatus consistent with the present
disclosure when cultivating lettuces

| | | 1 d | 2 d | 3 d | 4 d | 5 d | 6 d | 7 d | 8 d | 9 d | 10 d |
|---|---|---|---|---|---|---|---|---|---|---|---|
| EC | Non-coating plant | 1.5 | 1.5 | 1.4 | 1.4 | 1.3 | 1.3 | 1.2 | 1.5 | 1.5 | 1.5 |
| | cultivation | | | | | | | | | | |
| | apparatus | | | | | | | | | | |
| | Bicolored plant | 1.5 | 1.5 | 1.5 | 1.4 | 1.4 | 1.3 | 1.3 | 1.3 | 1.2 | 1.2 |
| | cultivation | | | | | | | | | | |
| | apparatus | | | | | | | | | | |
| pH | Non-coating plant | 6.5 | 6.6 | 6.8 | 6.9 | 7.1 | 7.1 | 7.2 | 6.5 | 6.5 | 6.6 |
| | cultivation | | | | | | | | | | |
| | apparatus | | | | | | | | | | |
| | Bicolored plant | 6.5 | 6.5 | 6.6 | 6.6 | 6.6 | 6.6 | 6.7 | 6.8 | 6.8 | 6.8 |
| | cultivation | | | | | | | | | | |
| | apparatus | | | | | | | | | | |

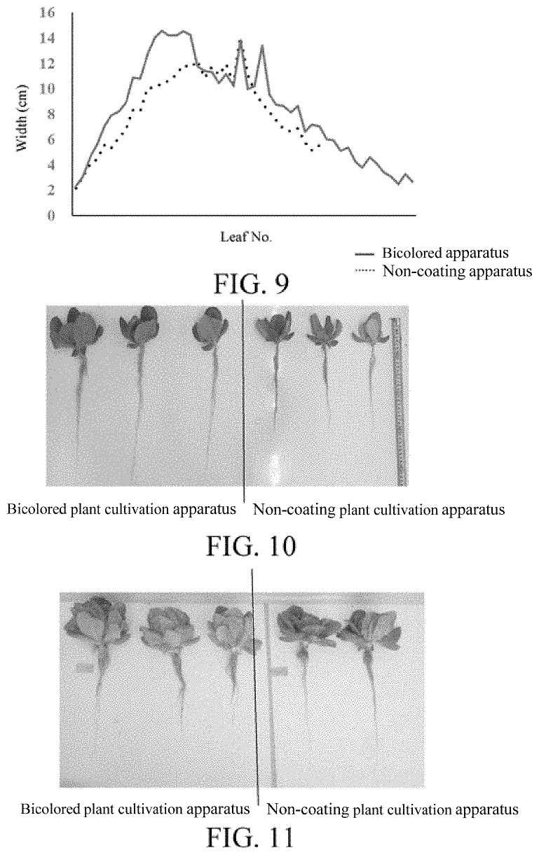

3. Growth indexes of lettuces: As shown in Table 4, when two lettuce cultivars were grown on a bicolored plant cultivation apparatus, the average weight and the maximum fresh weight of a single lettuce are significantly higher than those grown on the non-coating plant cultivation apparatus. For butterhead lettuces, there are total 46 leaves counted for one plant grown on the bicolored plant cultivation apparatus when compared with the 35 leaves counted for another plant grown on the non-coating plant cultivation apparatus. The corresponding leaves are smaller when compared one plant from the non-coating plant cultivation apparatus with another plant which has been grown on a bicolored plant cultivation apparatus (FIG. 8 and FIG. 9). Meanwhile, as shown in FIG. 10, FIG. 11 and Table 5, both the above-ground part and the root size of the lettuces grown on the bicolored plant cultivation apparatus are bigger than those grown on the non-coating plant cultivation apparatus.

TABLE 4
Fresh weight comparison of butterhead and Frillice lettuce
between the bicolored plant cultivation apparatus and the
non-coating plant cultivation apparatus (single white colour)

| | Non-coating plant | | | Bicolored plant | | | | |
|---|---|---|---|---|---|---|---|---|
| | cultivation apparatus | | | cultivation apparatus | | | | |
| | | Single | | | Single | | | |
| | | maximum | | | maximum | | Average | Harvest |
| | Average | fresh | Harvest | Average | fresh | Harvest | weight | time |
| | weight | weight | time | weight | weight | time | increase | decrease |
| | (g) | (g) | (d) | (g) | (g) | (d) | (%) | (%) |
| Butterhead | 81.6 | 123.5 | 45 | 152.9 | 202.5 | 40 | 187.5% | 11.1% |
| Frillice | 80.4 | 136.7 | 45 | 163.2 | 186.3 | 35 | 203.0% | 22.2% |

TABLE 5
Root length comparison between the bicolored plant cultivation
apparatus consistent with the present disclosure and the non-
coating plant cultivation apparatus (single white colour)

| | Root length | Root length |
|---|---|---|
| | (growing period) | (harvest) |
| Bicolored plant cultivation | 9.91 | 43.4 |
| apparatus | | |
| Non-coating plant cultivation | 7.82 | 39.7 |
| apparatus | | |

### Embodiment 5

As shown in FIG. 13, this embodiment discloses a bicolored plant cultivation apparatus, including a cultivation tank 30 and a planting plate 40. A plurality of planting through-holes (not shown in the figure) is placed on the planting plate 40 for fixing plant cultivation positions, and the shape of the planting through-hole includes, but is not limited to: a circular shape, a rectangular shape, or an elliptical shape. The planting plate 40 covers the cultivation tank 30 and fits with the cultivation tank 30 to form a cavity for storing a nutrient solution or a nutrient aerosol. Moreover, because the planting plate 40 covers the cultivation tank 30, a certain degree of isolation of the nutrient solution or the nutrient aerosol from the external environment is achieved, thereby reducing impact of the external environment on the nutrient solution or the nutrient aerosol. Preferably, the cultivation tank 30 and the planting plate 40 are made of plastic with a certain translucent effect, and the plastic includes, but is not limited to: PVC, PP, and the like.

Because the cultivation tank 30 has a certain translucent effect, a cultivation tank light-blocking layer 31 partially or completely covers an inner surface of the cultivation tank 30, so that algae in the nutrient solution or the nutrient aerosol contained in the cultivation tank 30 cannot obtain sufficient illumination and therefore cannot grow and reproduce, while a dark growing environment is provided for roots of plants. In other words, the cultivation tank light-blocking layer 31 may partially or completely cover an inner side wall of the cultivation tank 30, or partially or completely cover an inner bottom surface of the cultivation tank 30, or partially or completely cover both the inner side wall and the inner bottom surface of the cultivation tank 30. Moreover, the cultivation tank light-blocking layer 31 covering the inner surface of the cultivation tank 30 is not limited to one layer; in order to ensure the dark growing environment of the roots of the plants, multiple cultivation tank light-blocking layers 31 may be disposed.

Preferably, the cultivation tank light-blocking layer 31 completely covers the inner surface of the cultivation tank 30, that is, the inner side wall and the inner bottom surface. The cultivation tank light-blocking layer 31 may be made of plastic in a color with a light blocking effect or a coating in a color with a light blocking effect.

When the cultivation tank light-blocking layer 31 completely covers the inner surface of the cultivation tank 30 and the cultivation tank light-blocking layer 31 is made of plastic in a color with a light blocking effect, the cultivation tank light-blocking layer 31 and the cultivation tank 30 are fixed to each other through injection molding, lamination, adhesion, squeezing or thermoforming.

When the cultivation tank light-blocking layer 31 completely covers the inner surface of the cultivation tank 30 and the cultivation tank light-blocking layer 31 is made of a coating with a light blocking effect, the cultivation tank 30 is made of plastic with a certain translucent effect, and the cultivation tank light-blocking layer 31 and the cultivation tank 30 are fixed to each other through coating, lamination, adhesion or thermal transfer printing.

Similar to the cultivation tank 30, a lower surface (the surface facing the cultivation tank 30) of the planting plate 40 is also partially or completely covered with at least one planting plate light-blocking layer 41. The planting plate light-blocking layer 41 may also be made of plastic in a color with a light blocking effect or a coating in a color with a light blocking effect. A process for fixing the planting plate light-blocking layer 41 and the planting plate 40 to each other is related to the materials of the planting plate light-blocking layer 41 and the planting plate 40. Specifically the fixing process is the same as that used for the cultivation tank light-blocking layer 31 and the cultivation tank 30, and details are not described herein again.

Further, in the plant cultivation process, the roots of the plants need a dark environment while above-ground parts of the plants need a large amount of illumination. Therefore, in this embodiment, at least one planting plate light reflective layer 42 partially or completely covers an upper surface of the planting plate 40. Thus, in addition to blocking sunlight out of the cultivation tank 30, the planting plate 40 can also reflect sunlight incident on the upper surface of the planting plate 40, so that the plants can obtain a higher light intensity and consume less energy. The planting plate light reflective layer 42 may be made of plastic in a color with a light reflective effect or a coating in a color with a light reflective effect.

When the planting plate light reflective layer 42 completely covers the upper surface of the planting plate 40 and the planting plate light reflective layer 42 is made of plastic in a color with a light reflective effect, the planting plate light reflective layer 42 and the planting plate 40 are fixed to each other through injection molding, lamination, adhesion, squeezing or thermoforming.

When the planting plate light reflective layer 42 completely covers the upper surface of the planting plate 40 and the planting plate light reflective layer 42 is made of a coating in a color with a light reflective effect, the planting plate 40 is made of plastic with a certain translucent effect, and the planting plate light reflective layer 42 and the planting plate 40 are fixed to each other through coating, lamination, adhesion or thermal transfer printing.

Similar to the planting plate 40, an outer surface of the cultivation tank 30 is partially or completely covered with a cultivation tank light reflective layer 32. The cultivation tank light reflective layer 32 may partially or completely cover an outer side wall of the cultivation tank 30, or partially or completely cover an outer bottom surface of the cultivation tank 30, or partially or completely cover both the outer side wall and the outer bottom surface of the cultivation tank 30. Moreover, in this embodiment, the cultivation tank light reflective layer 32 covering the outer surface of the cultivation tank 30 is not limited to one layer, and multiple cultivation tank light reflective layers 32 may also be disposed. Similarly, the cultivation tank light reflective layer 32 may be made of plastic in a color with a light reflective effect or a coating in a color with a light reflective effect. A process for fixing the cultivation tank light reflective layer 32 and the cultivation tank 30 to each other is related to the materials of the cultivation tank light reflective layer 32 and the cultivation tank 30. Specifically the fixing process is the same as that used for the planting plate light reflective layer 42 and the planting plate 40, and details are not described herein again.

The colors used for the cultivation tank light-blocking layer 31 and the planting plate light-blocking layer 41 include but not limited to: black, blue, purple, dark grey, green, and the like. When taking Pantone's colour card as an example, the colour number chosen for blue is: 2188c, 2189c, 3205c, 2136c, 7693c, 7694c, or the like; the colour number chosen for purple is: 273c, 274c, 275c, 2685c, or the like; the colour number chosen for green is: 7727c, 7728c, or the like; the colour number chosen for dark grey is cold grey 5c-10c. The colours used for the cultivation tank light reflective layer 32 and the planting plate light reflective layer 42 include but not limited to: white, light grey, or fluorescent colour, and the like. When taking Pantone's colour card as an example, the colour number chosen for light grey is cold grey 1c. Preferably, a colour with a light reflective rate greater than 75% will be selected. It is not necessary to choose the same colours for the cultivation tank and the planting plate as their light blocking or light reflective layers at the same time.

The planting plate 40 of the bicolored cultivation apparatus disclosed in this embodiment is rectangular in shape, while the cultivation tank 30 is of a cubic structure. Therefore, both the planting plate light reflective layer 42 and the planting plate light-blocking layer 41 are fixed onto the planting plate 40 in a process when manufacturing the planting plates. The same strategy could be used to fix the cultivation tank light-blocking layer 31 and the cultivation tank light reflective layer 32 onto the cultivation tank 30. Whatever manufacturing methods used to achieve the same light blocking and light reflection effects for the bicolored cultivation apparatus are covered by the present disclosure.

Preferably, the cultivation tank of the cubic structure in this embodiment may also be formed by splicing plates together: plastic or a coating in a color with a light blocking effect and plastic or a coating in a color with a light reflective effect are fixed to plates (plastic) used as the cultivation tank to form a whole, thereby obtaining plates having both the light blocking effect and the light reflective effect; then the plates are spliced to form the cultivation tank 30 having the cultivation tank light-blocking layer 31 and the cultivation tank light reflective layer 32. Besides, colors of the light-blocking layers on the plates of the spliced cultivation tank 30 may be the same or different, so do the colors of the light reflective layers on the plates.

As sizes of cultivation devices in protected land facilities and plant factories are increasingly larger, the cultivation tank 30 having the cultivation tank light reflective layer 32 and the cultivation tank light-blocking layer 31 as well as the planting plate 40 having the planting plate light reflective layer 42 and the planting plate light-blocking layer 41 has an increasingly larger area, and mass production becomes relatively difficult. When the light reflective layer and the light-blocking layer are both made of plastic, the cultivation tank 30 having the cultivation tank light reflective layer 32 and the cultivation tank light-blocking layer 31 as well as the planting plate 40 having the planting plate light reflective layer 42 and the planting plate light-blocking layer 41 in this embodiment is preferably formed by means of thermoforming. Using the forming of the planting plate 40 having the planting plate light reflective layer 42 and the planting plate light-blocking layer 41 as an example, the planting plate light-blocking layer 41 is laid on a thermoforming workbench, and then the planting plate 40 is laid on the planting plate light-blocking layer 41; the planting plate 40 is rolled by using a roll welding apparatus, and the planting plate 40 is melted by heat during rolling in a few seconds and is bonded with the planting plate light-blocking layer 41 under the pressure of rolling; finally, the planting plate light reflective layer 42 is laid on the planting plate, and is bonded with the planting plate 40 having the planting plate light-blocking layer 41 by using a roll welding apparatus. When the light reflective layer and the light-blocking layer are both made of coatings, the cultivation tank 30 having the cultivation tank light reflective layer 32 and the cultivation tank light-blocking layer 31 as well as the planting plate 40 having the planting plate light reflective layer 42 and the planting plate light-blocking layer 41 in this embodiment is preferably formed by means of thermal transfer printing. Using the forming of the planting plate 40 having the planting plate light reflective layer 42 and the planting plate light-blocking layer 41 as an example, plastic that has a certain translucent effect and is used as the planting plate 40 is laid on a thermal transfer printing device; a thermal transfer printing coating in a color with a light reflective effect is fed in and positioned with the plastic of the planting plate 40, and the transfer printing coating is adhered to the plastic of the planting plate 40 through lamination and vacuumizing, and a one-minute hot melting process is performed; finally, thermal transfer printing and cooling setting are performed. Thus, the planting plate 40 having the planting plate light reflective layer 42 is formed. Preparation of the planting plate light-blocking layer 41 is the same as that of the planting plate light reflective layer 42, and details are not described herein again.

Preferably, one of the simplest and cost effective coating methods for mass production should be thermoforming or thermal transfer printing with a thickness between 0.5 and 7 mm. The preferable thickness of coating is between 2.5 mm and 3.5 mm which are durable when undergoing multiple rinses.

It should be noted that the shapes of the planting plate and the cultivation tank of the bicolored cultivation apparatus disclosed in this embodiment are not limited to the rectangular plate and the cubic structure shown in the figures. Any other types of planting plate and cultivation tank which can be connected to form a cavity for storing nutrient solutions will fall within the protection scope of the present disclosure.

### Embodiment 6

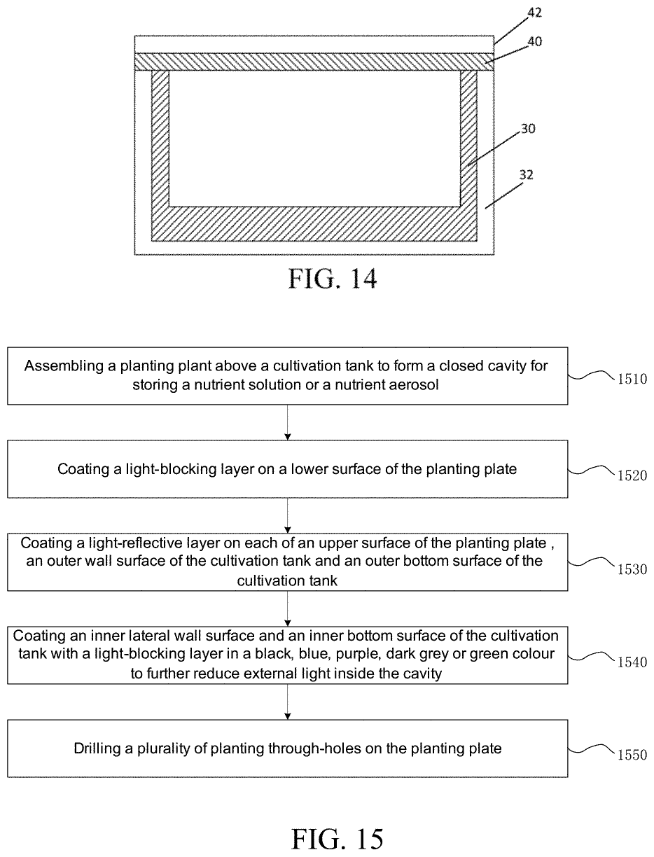

As shown in FIG. 14, this embodiment discloses a bicolored plant cultivation apparatus, the structure of which is similar to that of Embodiment 5. The bicolored plant cultivation apparatus includes a cultivation tank 30 and a planting plate 40. A plurality of planting through-holes (not shown in the figure) is placed on the planting plate 40 for fixing plant cultivation positions, and the shape of the planting through-hole includes, but is not limited to: a circular shape, a rectangular shape, or an elliptical shape. The planting plate 40 fits with the cultivation tank 30 to form a cavity for storing a nutrient solution or a nutrient aerosol.

This embodiment is different from Embodiment 5 in that the planting plate 40 and the cultivation tank 30 are directly made of plastic in a color with a light blocking effect, so that algae in the nutrient solution or the nutrient aerosol stored in the cultivation tank 30 cannot obtain sufficient illumination and therefore cannot grow and reproduce, while a dark growing environment is provided for roots of plants. The plastic includes, but is not limited to: PVC, PP, and the like.

Further, in a plant cultivation process, the roots of the plants need a dark environment while above-ground parts of the plants need a large amount of illumination. Therefore, in this embodiment, at least one planting plate light reflective layer 42 partially or completely covers an upper surface of the planting plate 40. Thus, in addition to blocking sunlight out of the cultivation tank 30, the planting plate 40 can also reflect sunlight incident on the upper surface of the planting plate 40, so that the plants can obtain sufficient light intensity and consume less energy. The planting plate light reflective layer 42 may be made of plastic in a color with a light reflective effect or a coating in a color with a light reflective effect.

When the planting plate light reflective layer 42 completely covers the upper surface of the planting plate 40 and the planting plate light reflective layer 42 is made of plastic in a color with a light reflective effect, the planting plate light reflective layer 42 and the planting plate 40 are fixed to each other through injection molding, lamination, adhesion, squeezing or thermoforming.

When the planting plate light reflective layer 42 completely covers the upper surface of the planting plate 40 and the planting plate light reflective layer 42 is made of a coating in a color with a light reflective effect, the planting plate 40 is made of plastic with a certain translucent effect, and the planting plate light reflective layer 42 and the planting plate 40 are fixed to each other through coating, lamination, adhesion or thermal transfer printing.

Similar to the planting plate 40, an outer surface of the cultivation tank 30 is partially or completely covered with a cultivation tank light reflective layer 32. The cultivation tank light reflective layer 32 may partially or completely cover an outer side wall of the cultivation tank 30, or partially or completely cover an outer bottom surface of the cultivation tank 30, or partially or completely cover both the outer side wall and the outer bottom surface of the cultivation tank 30. Moreover, in this embodiment, the cultivation tank light reflective layer 32 covering the outer surface of the cultivation tank 30 is not limited to one layer, and multiple cultivation tank light reflective layers 32 may also be disposed. Similarly, the cultivation tank light reflective layer 32 may be made of plastic in a color with a light reflective effect or a coating in a color with a light reflective effect. A process for fixing the cultivation tank light reflective layer 32 and the cultivation tank 30 to each other is related to the materials of the cultivation tank light reflective layer 32 and the cultivation tank 30. Specifically the fixing process is the same as that used for the planting plate light reflective layer 42 and the planting plate 40, and details are not described herein again.

Further, the colors used for the cultivation tank 30 and the planting plate 40 include but not limited to: black, blue, purple, dark grey, green, and the like. When taking Pantone's colour card as an example, the colour number chosen for blue is: 2188c, 2189c, 3205c, 2136c, 7693c, 7694c, or the like; the colour number chosen for purple is: 273c, 274c, 275c, 2685c, or the like; the colour number chosen for green is: 7727c, 7728c, or the like; the colour number chosen for dark grey is cold grey 5c-10c. The colours used for the cultivation tank light reflective layer 32 and planting plate light reflective layer 42 include but not limited to: white, light grey, or fluorescent colour, and the like. When taking Pantone's colour card as an example, the colour number chosen for light grey is cold grey 1c. Preferably, a colour with a light reflective rate greater than 75% will be selected. It is not necessary to choose the same colours for the cultivation tank and the planting plate as their light blocking or light reflective layers at the same time.

The planting plate 40 of the bicolored cultivation apparatus disclosed in this embodiment is rectangular in shape, while the cultivation tank 30 is of a cubic structure. Therefore, the light reflective layer 42 is fixed onto the planting plate 40 in a process when manufacturing the planting plates. The same strategy could be used to fix the light reflective layer 32 onto the cultivation tank 30.

Further, the cultivation tank of the cubic structure in this embodiment may also be formed by splicing plates together: plastic or a coating in a color with a light reflective effect is fixed to plates (plastic) that are in a color with a light blocking effect and used as the cultivation tank to form a whole, thereby obtaining plates having both the light blocking effect and the light reflective effect; then the plates are spliced to form the cultivation tank 30 having the cultivation tank light reflective layer 32. Besides, colors of the plates of the spliced cultivation tank 30 may be the same or different, so do the colors of the light reflective layers on the plates.

As sizes of cultivation apparatuses in controlled environment facilities and plant factories are increasingly larger, the cultivation tank 30 having the cultivation tank light reflective layer 32 as well as the planting plate 40 having the planting plate light reflective layer 42 has an increasingly larger area, and mass production becomes relatively difficult. When the light reflective layer is made of plastic, the cultivation tank 30 having the cultivation tank light reflective layer 32 as well as the planting plate 40 having the planting plate light reflective layer 42 in this embodiment is preferably formed by means of thermoforming. Using the forming of the planting plate 40 having the planting plate light reflective layer 42 as an example, the planting plate 40 is laid on a thermoforming workbench, and then the planting plate light reflective layer 42 is laid on the planting plate 40; the planting plate light reflective layer 42 is rolled by using a roll welding apparatus, and planting plate light reflective layer 42 is melted by heat during rolling in a few seconds and is bonded with the planting plate 40 under the pressure of rolling. When the light reflective layer is made of a coating, the cultivation tank 30 having the cultivation tank light reflective layer 32 as well as the planting plate 40 having the planting plate light reflective layer 42 in this embodiment is preferably formed by means of thermal transfer printing. Using the forming of the planting plate 40 having the planting plate light reflective layer 42 as an example, plastic that has a certain translucent effect and is used as the planting plate 40 is laid on a thermal transfer printing device; a thermal transfer printing coating in a color with a light reflective effect is fed in and positioned with the plastic of the planting plate 40, and the transfer printing coating is adhered to the plastic of the planting plate 40 through lamination and vacuumizing, and a one-minute hot melting process is performed; finally, thermal transfer printing and cooling setting are performed. Thus, the planting plate 40 having the planting plate light reflective layer 42 is formed.

Preferably, one of the simplest and cost effective coating methods for mass production should be thermoforming or thermal transfer printing with a thickness between 0.5 and 7 mm. The preferable thickness of coating is between 2.5 mm and 3.5 mm which are durable when undergoing multiple rinses. Despite being thin, the cultivation apparatus in this embodiment is endurable, has a high bearing capacity and high strength, does not deform easily, and is highly stable and easy to clean.

In addition, in order to ensure the dark environment for the roots of the plants, one or more cultivation tank light-blocking layers may also partially or completely cover an inner surface of the cultivation tank 30, and one or more planting plate light-blocking layers may also partially or completely cover a lower surface of the planting plate 40. Such a structure is similar to that in Embodiment 5, and details are not described herein again.

FIG. 15 illustrates a flow chart of a method for manufacturing the bicolored plant cultivation apparatus. At block 1510, the planting plant is assembled above a cultivation tank to form a closed cavity for storing a nutrient solution or a nutrient aerosol. At block 1520, the light-blocking layer is coated on a lower surface of the planting plate. At block 1530, the light-reflective layer is coated on each of an upper surface of the planting plate, an outer wall surface of the cultivation tank and an outer bottom surface of the cultivation tank. At block 1540, the inner lateral wall surface and the inner bottom surface of the cultivation tank is coated with a light-blocking layer in a black, blue, purple, dark grey or green colour to further reduce external light inside the cavity. At block 1550, a plurality of planting through-holes is drilled on the planting plate.

It should be noted that the shapes of the planting plate and the cultivation tank of the bicolored cultivation apparatus disclosed in this embodiment are not limited to the rectangular plate and the cubic structure shown in the figures. Any other types of planting plate and cultivation tank which can be connected to form a cavity for storing nutrient solutions will fall within the protection scope of the present disclosure.

A person of ordinary skill in the art can know that use of the planting plate in the present disclosure alone, use of the cultivation tank in the present disclosure alone, and use of the planting plate and the cultivation tank in the present disclosure together all fall within the protection scope of the present disclosure. Any planting plates or cultivation tanks with the same or similar light blocking and light reflection functions will fall within the protection scope of the present disclosure.

In conclusion, because roots of normal plants grow in a dark environment, the light-blocking layer of the bicolored plant cultivation apparatus consistent with the present disclosure can minimize the illumination intensity of the cavity formed by the planting plate and the cultivation tank, so that a dark environment is created for growth of roots of cultivated crops, thereby facilitating growth and development of the roots. In the present disclosure, the cavity is kept in a dark environment to make the nutrient solution or the nutrient aerosol more stable and prevent growth of algae, thereby reducing interference of the algae with the nutrient solution or the nutrient aerosol. Therefore, the nutrient solution or the nutrient aerosol has a stronger buffering capability and is more stable; the element content and ratio as well as pH and EC of the nutrient solution or the nutrient aerosol change in a small range, thereby facilitating growth of the cultivated crops. Moreover, the nutrient solution or the nutrient aerosol has higher dissolved oxygen content. Because there are no algae to absorb oxygen, the roots of the cultivated crops can absorb more oxygen, thereby facilitating growth of the roots and nutrition absorption. The light reflective layer of the cultivation apparatus consistent with the present disclosure has high reflectivity, and therefore can reduce energy loss and ensure light intensity required by the cultivated crops. The bicolored cultivation apparatus consistent with the present disclosure is simple in its structure and can be manufactured through different ways which are suitable for mechanical (industrial level) mass production. The present disclosure effectively overcomes the defects from the existing non-coating cultivation apparatus. Using the bicolored plant cultivation apparatus for a plant factory will greatly enhance its productivity with low energy consumption.

The above mentioned embodiments are for illustration purpose only in order to describe the principles and effectiveness of the present disclosure and they are not for limiting the scope of the present disclosure. Without going against the spirit and the range of the present disclosure, anyone skilled in the art can make modifications or changes to the above-mentioned embodiments. Therefore, all equivalent modifications or changes without departing from the spirit and technical concept disclosed by the present disclosure should be covered by the claims of the present disclosure.

What is claimed is:

1. A method for manufacturing a bicolored plant cultivation apparatus, comprising:
assembling a planting plant above a cultivation tank to form a closed cavity for storing a nutrient solution or a nutrient aerosol; and
coating a light-blocking layer on a lower surface of the planting plate, wherein
the cavity creates a low light environment for plant root and reduces growth of algae inside the nutrient solution or the nutrient aerosol, and
the light-blocking layer is fabricated by injection moulding, film coating, adhesion, squeezing, thermal transfer printing or thermoforming.

2. The method as in claim 1, further comprising:
coating a light-reflective layer on each of an upper surface of the planting plate, an outer wall surface of the cultivation tank and an outer bottom surface of the cultivation tank, wherein
the light-reflective layer is in a white, light grey, or fluorescent color to enhance light reflection, and
the light reflective layer is fabricated by injection moulding, film coating, adhesion, squeezing, thermal transfer printing or thermoforming.

3. The method as in claim 1, further comprising:
coating an inner lateral wall surface and an inner bottom surface of the cultivation tank with a light-blocking layer in a black, blue, purple, dark grey or green colour to further reduce external light inside the cavity.

4. The method as in claim 1, wherein a colour of the light-blocking layer includes black, blue, purple, dark grey, or green.

5. The method as in claim 1, further comprising:
drilling a plurality of planting through-holes on the planting plate.

6. The method as in claim 1, wherein
the light-blocking layer is made by using a coloured plastic with a light-blocking effect, the coloured plastic is fixed onto one side of the planting plate through injection moulding, lamination, adhesion, squeezing or thermoforming; or
the light-blocking layer is made by using a coloured film with a light-blocking effect, the coloured film is fixed onto one side of the planting plate through coating, lamination, adhesion or thermal transfer printing.

7. The method as in claim 2, wherein
the light reflective layer is made by using a coloured plastic with a light reflective effect, the coloured plastic is fixed onto one side of the planting plate through injection moulding, lamination, adhesion, squeezing or thermoforming; or
the light reflective layer is made by using a coloured film with a light reflective effect, the coloured film is fixed onto one side of the planting plate through coating, lamination, adhesion or thermal transfer printing.
